(19) United States
(12) Patent Application Publication
(10) Pub. No.: US 2013/0144934 A1
(43) Pub. Date: Jun. 6, 2013

(54) Web Content Targeting Based on Client Application Availability

(71) Applicants: Alberto Swett, Redmond, WA (US); Olivier M. Destrebecq, Seattle, WA (US); Kenneth J. Yuhas, JR., Seattle, WA (US); Trevor W. McDiarmid, Seattle, WA (US); Garland Trice, Redmond, WA (US)

(72) Inventors: Alberto Swett, Redmond, WA (US); Olivier M. Destrebecq, Seattle, WA (US); Kenneth J. Yuhas, JR., Seattle, WA (US); Trevor W. McDiarmid, Seattle, WA (US); Garland Trice, Redmond, WA (US)

(73) Assignee: MICROSOFT CORPORATION, Redmond, WA (US)

(21) Appl. No.: 13/309,231

(22) Filed: Dec. 1, 2011

(51) Int. Cl. G06F 15/16

(52) U.S. Cl. 709/203

(57) ABSTRACT

Targeting content from an online service is provided. A server may query a plug-in in a client application to determine whether an application is installed on a client computing device for viewing the content from the online service. The server may then receive a response to the query from the plug-in. The server may then query a web service to determine a license status for a roaming application for viewing the content from the online service the client computing device. The server may then receive a response to the query from the web service. The server may then present one or more options for targeting the content from the online service to the client computing device based on the response to the query from the plug-in and the response to the query from the web service.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Online computing services enable users to retrieve applications files from a Web site for use on a client computer. For example, a productivity software manufacturer Web site may offer a downloading service for downloading a word processing file, for viewing and/or editing on a user's computer, which may be formatted for use with a particular software application. If the user does not have the required software application on the computer to which the file is being downloaded, the user will not be able to open the file. While some online services are capable of identifying software applications (through the use of a plug-in) on connected client computers, these services fail to provide users with options (e.g., offering the user an alternative method for viewing or opening the file) in the event that none of the software applications identified on a user's machine are able to open a file being offered for download. It is with respect to these considerations and others that the various embodiments described herein have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for targeting content from an online service to a client computing device. A server may query a plug-in in a client application to determine whether an application is installed on the client computing device for viewing the content from the online service. The server may then receive a response to the query from the plug-in. The server may then query a web service to determine a license status for a roaming application for viewing the content from the online service the client computing device. The server may then receive a response to the query from the web service. The server may then present one or more options for targeting the content from the online service to the client computing device based on the response to the query from the plug-in and the response to the query from the web service.

These and other features and advantages will be apparent from a reading of the following detailed description and a review of the associated drawings. It is to be understood that both the foregoing general description and the following detailed description are illustrative only and are not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 shows a network architecture for targeting content from an online service in a distributed computing environment, in accordance with an embodiment;

FIG. 2 is a flow diagram illustrating a routine for targeting content from an online service, in accordance with an embodiment;

FIG. 3 is a flow diagram illustrating a routine for presenting options for targeting content from an online service, in accordance with an embodiment;

FIG. 4 is a simplified block diagram of a computing device with which various embodiments may be practiced;

FIG. 5A is a simplified block diagram of a mobile computing device with which various embodiments may be practiced; and

FIG. 5B is a simplified block diagram of a mobile computing device with which various embodiments may be practiced.

### DETAILED DESCRIPTION

Embodiments are provided for targeting content from an online service to a client computing device. A server may query a plug-in in a client application to determine whether an application is installed on the client computing device for viewing the content from the online service. The server may then receive a response to the query from the plug-in. The server may then query a web service to determine a license status for a roaming application for viewing the content from the online service the client computing device. The server may then receive a response to the query from the web service. The server may then present one or more options for targeting the content from the online service to the client computing device based on the response to the query from the plug-in and the response to the query from the web service.

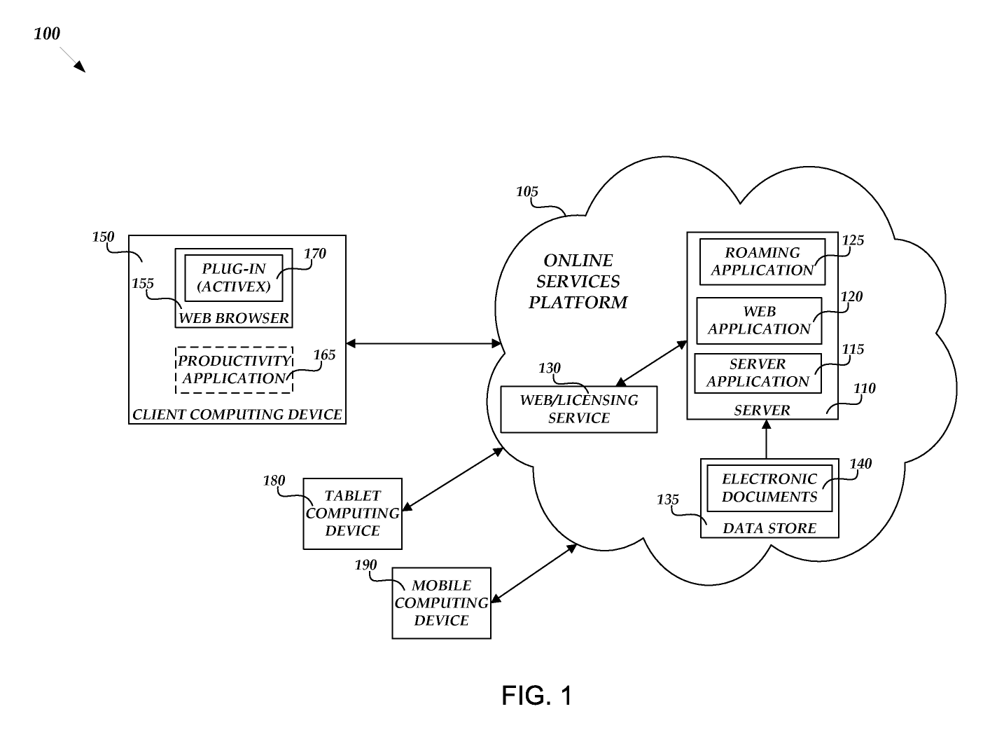

FIG. 1 shows a network architecture 100 for targeting content from an online service in a distributed computing environment, in accordance with an embodiment. The network architecture 100 includes a online services platform 105 which is in communication with client computing device 150, a tablet computing device 180 and a mobile computing device 190.

In accordance with an embodiment, the online services platform 105 may comprise a generic cloud-based service for providing content such as the WINDOWS AZURE PLATFORM service from MICROSOFT CORPORATION of Redmond, Wash. It should be understood, however, that other online services platforms programs from other service providers may be utilized in accordance with the various embodiments described herein. The online services platform 105 may comprise a server 110, a web/licensing service 130 and a data store 135 for storing electronic documents 140.

The server 110 may comprise a computing device which hosts a website which may be utilized by users of the computing devices to access web-based productivity applications and the electronic documents 140 stored in the data store 135. The server 110 may include at least one processing unit and a system memory and may further host a server application 115, a web application 120 and a roaming application 125. As will be described in greater detail below, the server application 115 may be configured to facilitate web content targeting based on the availability of a compatible client application on one or more of the client computing device 150, the tablet computing device 180 and the mobile computing device 190 by: (1) querying a plug-in on a computing device to determine a client application for viewing the web content (e.g., one or more of the electronic documents 140); (2) querying a web service to determine a license status for the roaming application 125; and (3) presenting one or more options to the computing device based on the responses to the aforementioned queries.

In accordance with an embodiment, the web application 120 may comprise a web-based version of a productivity application suite which allows users to access documents directly from anywhere in a web browser as well as share files and collaborate with other users online. As will be described in greater detail below, the web application 120 may be utilized as an option for viewing content, such as one or more of the electronic documents 140, on the computing devices 150, 180 and 190. In accordance with an embodiment, the web application 120 may comprise one or more of the OFFICE WEB APPS web applications from MICROSOFT CORPORATION of Redmond, Wash. It should be understood, however, that other web applications from other manufacturers may be utilized in accordance with the various embodiments described herein.

The roaming application 125 may comprise full versions of one or more productivity applications required for viewing content which may be downloaded from the server 110 to one or more of the computing devices 150, 180 and 190. As will be described in greater detail below, the web application 120 may be utilized as an option for viewing content, such as one or more of the electronic documents 140, by licensed application users. In accordance with an embodiment, the roaming application 125 may be streamed from the server 110 enabling some features of the application to be accessible to users before the entire application has finished downloading to a client computing device. Thus, it should be appreciated that the roaming application 125 may enable use of various applications features more quickly than a typical installation in which application features are inaccessible until the entire application has been installed on a client computing device.

The web/licensing service 130 may comprise a Web-based service which is hosted by the online services platform 105. In accordance with an embodiment, the web/licensing service 130 is an application program interface (“API”) which may communicate a license status for a user of one or more of the computing devices 150, 180 and 190 to the server application 115. In particular, and as will be described in greater detail below, the web/licensing service 130 may determine whether or not a user has a license for the roaming application 125 for viewing content on the computing devices 150, 180 and 190.

The data store 135 may be in communication with the server 110 and may be utilized for storing the electronic documents 140 for later viewing/opening by one or more of the computing devices 150, 180 and 190 utilizing either the web application 120, the roaming application 125 (hosted by the sever 110) or a productivity application installed on any of the aforementioned computing devices. In accordance with an embodiment, the electronic documents 140 may include, without limitation, word processing documents, presentation documents, spreadsheet documents note-taking documents.

As briefly discussed above, the client computing device 150 is in communication with the online services platform 105 and may include a web browser 155 and optionally include a productivity application 155. The web browser 155 may include a plug-in 170. In accordance with an embodiment, the web browser 155 may comprise the INTERNET EXPLORER web browser and the plug-in 170 may comprise the ACTIVEX control from MICROSOFT CORPORATION of Redmond, Wash. It should be understood, however, that other web browsers and plug-ins from other manufacturers may be utilized in accordance with the various embodiments described herein. For example, the web browser 155 may alternatively comprise the FIREFOX web browser from MOZILLA CORPORATION of Mountain View, Calif., the GOOGLE CHROME web browser from GOOGLE INC. of Mountain View, Calif. or the SAFARI web browser from APPLE INC. of Cupertino, Calif. In accordance with an embodiment, the web browser 155 may be utilized to view web pages generated by the online services platform 105 and the plug-in 170 may be queried by the server application 115 to determine if a client or productivity software application is installed on the client computing device 150 for viewing web content (e.g., one or more of the electronic documents 140) from an online service (i.e., the online services platform 105). The productivity application 165 may comprise one or more software application programs which may optionally be installed on the client computing device 150 for viewing or opening the electronic documents 140 from online services platform 105. In accordance with an embodiment, the productivity application 165 may comprise the WORD word processing software, POWERPOINT presentation graphics software, EXCEL spreadsheet software, and ONENOTE note-taking software from MICROSOFT CORPORATION of Redmond Wash. It should be appreciated that the aforementioned software applications may comprise individual application programs or alternatively, may be incorporated into a suite of productivity applications such as the OFFICE application program suite from MICROSOFT CORPORATION. It should be understood, however, that other productivity application programs from other manufacturers may be utilized in accordance with the various embodiments described herein.

The tablet computing device 180 and the mobile computing device 190 may also be in communication with the online services platform 105. It should be understood that the aforementioned computing devices may include represent alternative computing environments in which the various embodiments described herein may be practiced. Thus, it will be appreciated that the tablet computing device 180 and the mobile computing device 190 may include many of the same software components discussed above with respect to the client computing device 150 including, but not limited to, the web browser 155, the plug-in 170 and the productivity application 165.

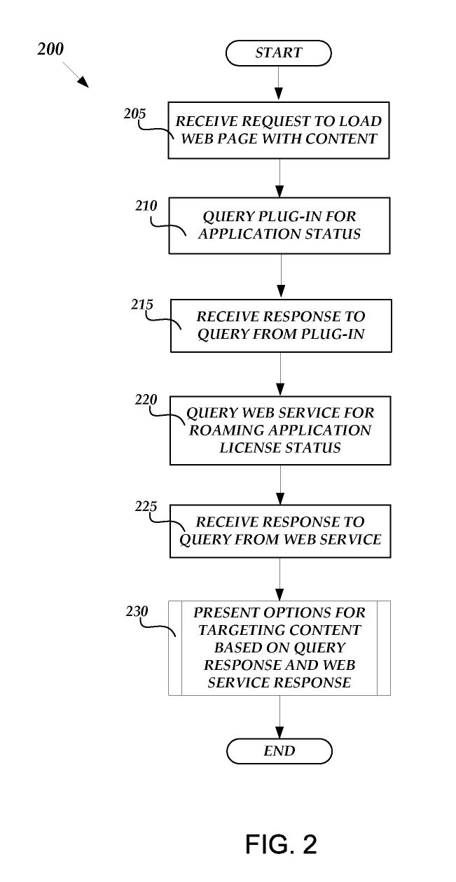

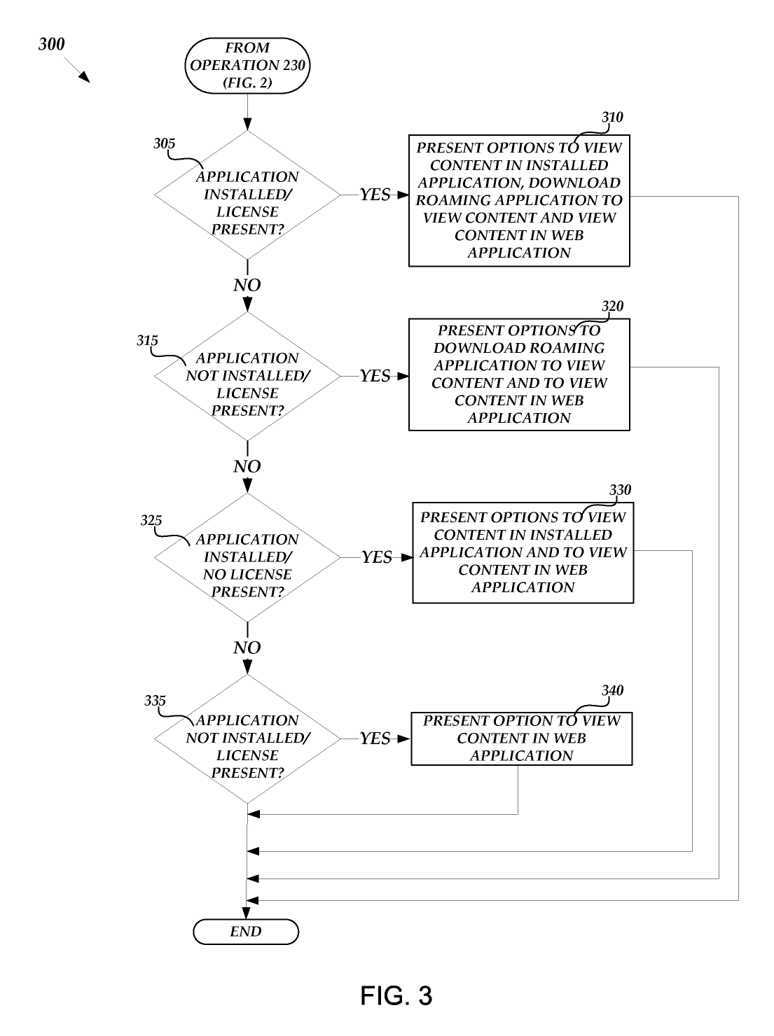

FIG. 2 is a flow diagram illustrating a routine 200 for targeting content from an online service, in accordance with an embodiment. When reading the discussion of the routine presented herein, it should be appreciated that the logical operations of various embodiments are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the various embodiments. Accordingly, the logical operations illustrated in FIGS. 2-3 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the various embodiments as recited within the claims set forth herein.

The routine 200 begins at operation 205, where the server application 115 executing on the server 110 (discussed above with respect to FIG. 1) may receive a request from a client computing device (such as the client computing device 150) to load a web page comprising the content from an online service. The content may comprise an electronic document generated by a productivity software application.

From operation 205, the routine 200 continues to operation 210, where the server application 115 executing on the server 110 may query the plug-in 170 to determine whether an application is installed on the client computing device 150 for viewing or opening the content from the online service. As discussed above with respect to FIG. 1, in accordance with an embodiment, the plug-in 170 may comprise an ActiveX control.

From operation 210, the routine 200 continues to operation 215, where the server application 115 executing on the server 110 may receive a response to the query made at operation 210 from the plug-in 170. For example, the plug-in 170 (or the ActiveX control) may either communicate a response to the server application 115 that a productivity application is installed on the client computing device 150 for viewing or opening the content from the online service or that no productivity application is installed on the client computing device 150 for viewing or opening the content from the online service.

From operation 215, the routine 200 continues to operation 220, where the server application 115 executing on the server 110 may query the web/licensing service 130 to determine a license status for the roaming application 125 for viewing or opening the content from the online service on the client computing device 150. For example, the server application 115 may query a web service (i.e., a licensing service) to determine if a user of the client computing device 150 has a license for a roaming application for the 2011 version of a word processing application which may be required for viewing or opening requested content from the online service. In accordance with an embodiment, users may be required to purchase or subscribe to a license for using the roaming application 125. The web/licensing service 130 may maintain license information for subscribers to the roaming application 125. The online services platform 105 (i.e., the online service) may be configured to require a user to login (e.g., with a user name and password) to access various applications and files hosted by the platform. The web/licensing service 130 may be configured to identify users based on user login information and then determine whether an identified user has purchased or subscribed to a license for the roaming application 125.

From operation 220, the routine 200 continues to operation 225, where the server application 115 executing on the server 110 may receive a response to the query made at operation 220 from the web/licensing service 130. For example, the web/licensing service 130 may either communicate a response to the server application 115 that a current user of the online service has a license for the roaming application 125 or that the current user does not have a license for the roaming application 125.

From operation 225, the routine 200 continues to operation 230, where the server application 115 executing on the server 110 may present at least one option for targeting the content from the online service to the client computing device 150 based on the response to the query from the plug-in 170 and the response to the query from the web/licensing service 130. In particular, the server application may generate a user interface on a web page which is displayed the web browser 155 on the client computing device 150 and which lists various options for selection by a user. The options which may be presented by the server application 115 will be described in greater detail below with respect to FIG. 3. From operation 230, the routine 200 then ends.

FIG. 3 is a flow diagram illustrating a routine 300 for presenting options for targeting content from an online service, in accordance with an embodiment. The routine 300 begins from operation 230 of FIG. 2 and continues to operation 305 where, based on the response to the query received from the plug-in 170 at operation 215 and the response to the query received from the web/licensing service 130 at operation 225, the server application 115 executing on the server 110 may determine whether a condition exists in which an application (e.g., the productivity application 165) is installed on the client computing device 150 and the current user has a license for the roaming application 125. If, at operation 305, it is determined that the aforementioned condition is true (i.e., the application is installed and that there is a license for the roaming application 125), then the routine 300 continues to operation 310. If, at operation 305, it is determined that the aforementioned condition is not true, then the routine 300 branches to operation 315.

At operation 310, the server application 115 executing on the server 110 may present all of the following options for targeting the content from the online service: (1) an option to view or open the content in the installed application on the client computing device 150; (2) an option to download the roaming application 125 which may then be used to view or open the content; and (3) an option to view the content in the web application 120 on the web browser 155. It should be appreciated that having a license to the roaming application 125 enables users to view or open content in a current full version of an application on computers installed with outdated versions of the application. For example, a licensed user of the roaming application 125 may be visiting a friend's home and wishes to open a word processing document, which is stored in the online services platform 105, on the friend's computer. The user may then discover that the friend has outdated version of the word processing application needed for viewing the document installed on their computer. However, the licensed user, upon logging onto the online services platform, may still view the document using the most recent version of the application by selecting the option to download the roaming application 125. From operation 310, the routine 300 then ends.

At operation 315, the server application 115 executing on the server 110 may determine whether a condition exists in which an application (e.g., the productivity application 165) is not installed on the client computing device 150 and the current user has a license for the roaming application 125. If, at operation 315, it is determined that the aforementioned condition is true, then the routine 300 continues to operation 320. If, at operation 315, it is determined that the aforementioned condition is not true, then the routine 300 branches to operation 325.

At operation 320, the server application 115 executing on the server 110 may present the following options for targeting the content from the online service: (1) an option to download the roaming application 125 which may then be used to view or open the content; and (2) an option to view the content in the web application 120 on the web browser 155. It should be appreciated that having a license to the roaming application 125 enables users to view or open content in a full version of an application on computers not having installed versions of the application. From operation 320, the routine 300 then ends.

At operation 325, the server application 115 executing on the server 110 may determine whether a condition exists in which an application (e.g., the productivity application 165) is installed on the client computing device 150 and the current user does not have a license for the roaming application 125. If, at operation 325, it is determined that the aforementioned condition is true, then the routine 300 continues to operation 330. If, at operation 325, it is determined that the aforementioned condition is not true, then the routine 300 branches to operation 335.

At operation 330, the server application 115 executing on the server 110 may present the following option for targeting the content from the online service: an option to view the content in the web application 120 on the web browser 155. From operation 330, the routine 300 then ends.

At operation 335, the server application 115 executing on the server 110 may determine whether a condition exists in which an application (e.g., the productivity application 165) is not installed on the client computing device 150 and the current user does not have a license for the roaming application 125. If, at operation 335, it is determined that the aforementioned condition is true, then the routine 300 continues to operation 340. If, at operation 325, it is determined that the aforementioned condition is not true, then all of the conditions in the routine 300 have been satisfied and the routine 300 then ends.

At operation 340, the server application 115 executing on the server 110 may present the following option for targeting the content from the online service: an option to view the content in the web application 120 on the web browser 155. From operation 340, the routine 300 then ends.

It should be understood that, in accordance with an embodiment, there may be instances in which fewer or none of the options discussed above in the routine 300 are presented by the server application 115. For example, if the server application 115 receives a request for content comprising a file type for which a web application does not exist, the option to view the content in a web application will not be presented to a user under any of the conditions discussed above in the routine 300.

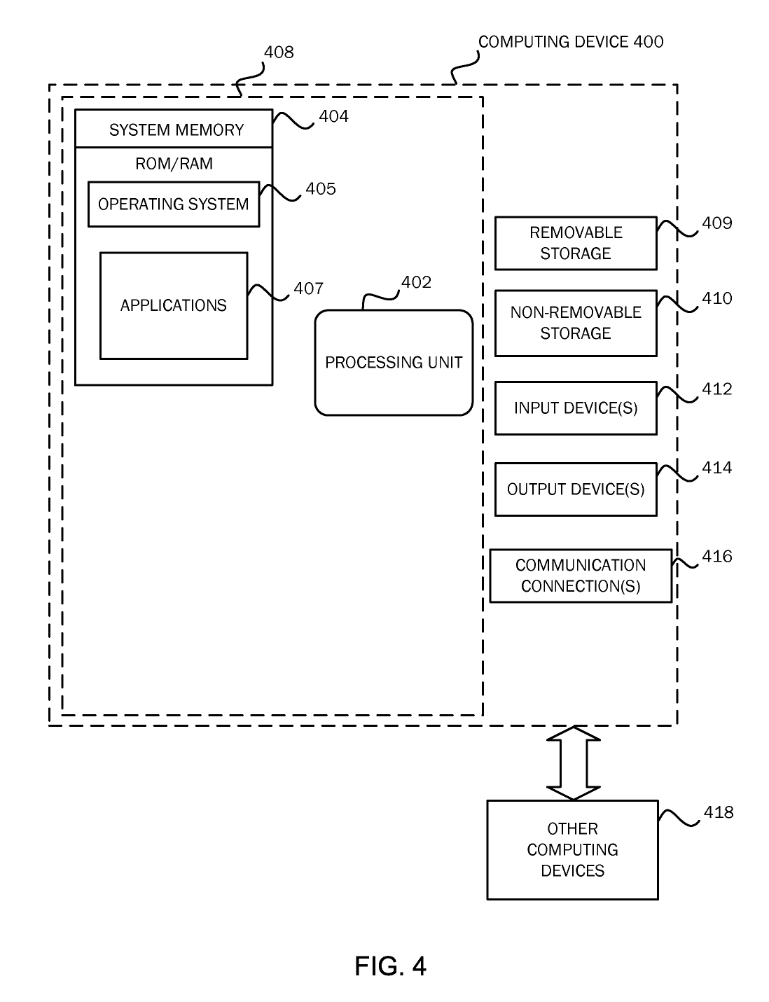

FIG. 4 is a block diagram illustrating example physical components of a computing device 400 with which various embodiments may be practiced. The computing device components described below may be suitable for the client computing device 150 or the server 110 described above with respect to FIG. 1. In a basic configuration, the computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include an operating system 405 and applications 407. Operating system 405, for example, may be suitable for controlling computing device 400's operation and, in accordance with an embodiment, may comprise the WINDOWS operating systems from MICROSOFT CORPORATION of Redmond, Wash. It should be understood that the embodiments described herein may also be practiced in conjunction with other operating systems and application programs and further, is not limited to any particular application or system.

The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage 409 and a non-removable storage 410.

Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 400 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 400. Any such computer storage media may be part of the computing device 400. The computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

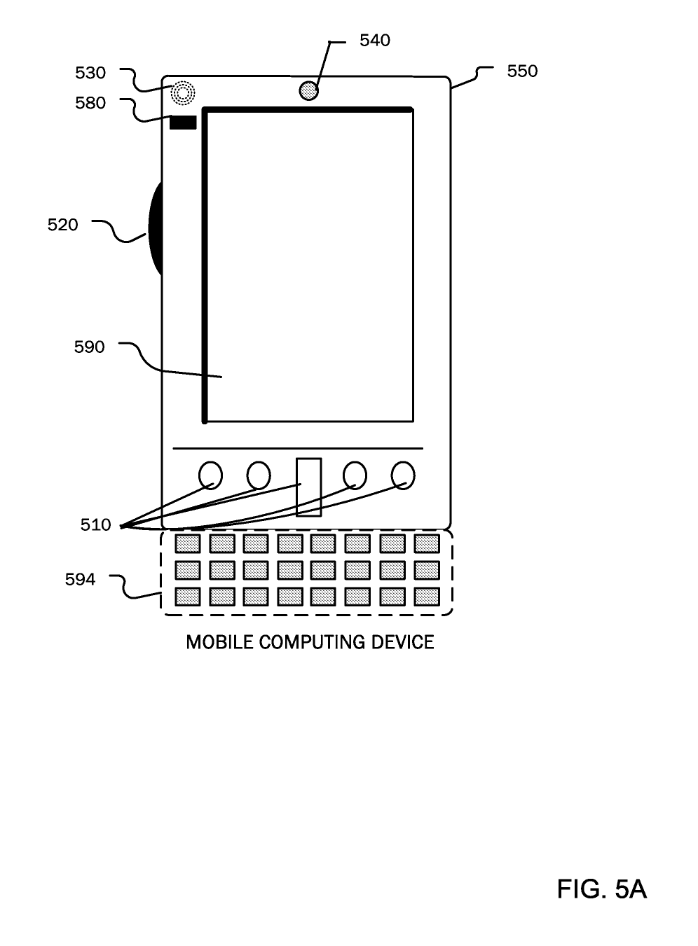

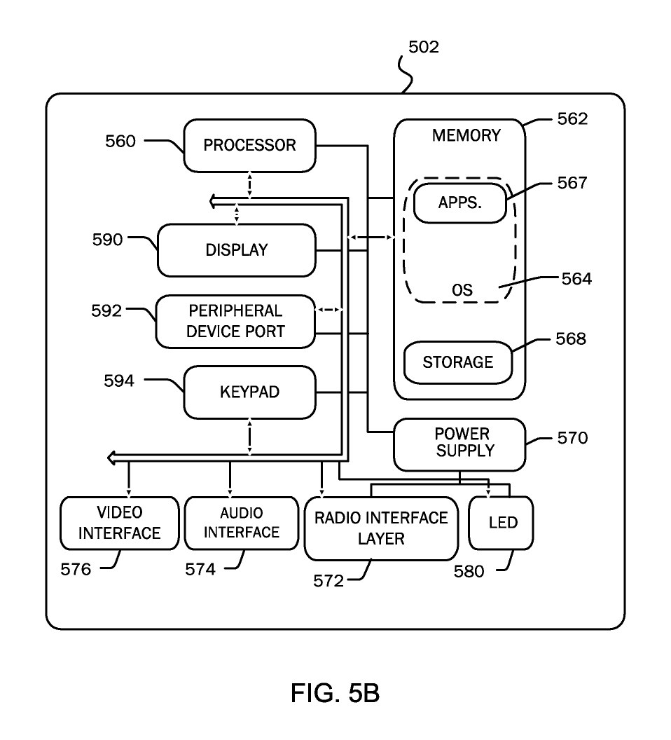

FIGS. 5A and 5B illustrate a suitable mobile computing environment, for example, a mobile computing device 550, a smartphone, a tablet personal computer, a laptop computer, and the like, with which various embodiments may be practiced. With reference to FIG. 5A, an example mobile computing device 550 for implementing the embodiments is illustrated. In a basic configuration, mobile computing device 550 is a handheld computer having both input elements and output elements. Input elements may include touch screen display 525 and input buttons 510 that allow the user to enter information into mobile computing device 550. Mobile computing device 550 may also incorporate an optional side input element 520 allowing further user input. Optional side input element 520 may be a rotary switch, a button, or any other type of manual input element. In alternative embodiments, mobile computing device 550 may incorporate more or less input elements. For example, display 525 may not be a touch screen in some embodiments. In yet another alternative embodiment, the mobile computing device is a portable phone system, such as a cellular phone having display 525 and input buttons 510. Mobile computing device 550 may also include an optional keypad 505. Optional keypad 505 may be a physical keypad or a “soft” keypad generated on the touch screen display.

Mobile computing device 550 incorporates output elements, such as display 525, which can display a graphical user interface (GUI). Other output elements include speaker 530 and LED light 526. Additionally, mobile computing device 550 may incorporate a vibration module (not shown), which causes mobile computing device 550 to vibrate to notify the user of an event. In yet another embodiment, mobile computing device 550 may incorporate a headphone jack (not shown) for providing another means of providing output signals.

Although described herein in combination with mobile computing device 550, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 5B is a block diagram illustrating components of a mobile computing device used in one embodiment, such as the mobile computing device 550 shown in FIG. 5A. That is, mobile computing device 550 can incorporate a system 502 to implement some embodiments. For example, system 502 can be used in implementing a “smart phone” that can run one or more applications similar to those of a desktop or notebook computer. In some embodiments, the system 502 is integrated as a computing device, such as an integrated personal digital assistant (PDA) and wireless phone.

Applications 567 may be loaded into memory 562 and run on or in association with an operating system 564. The system 502 also includes non-volatile storage 568 within memory the 562. Non-volatile storage 568 may be used to store persistent information that should not be lost if system 502 is powered down. The applications 567 may use and store information in the non-volatile storage 568. A synchronization application (not shown) also resides on system 502 and is programmed to interact with a corresponding synchronization application resident on a host computer to keep the information stored in the non-volatile storage 568 synchronized with corresponding information stored at the host computer. As should be appreciated, other applications may also be loaded into the memory 562 and run on the mobile computing device 550.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of OS 564. In other words, communications received by the radio 572 may be disseminated to the productivity application 567 via OS 564, and vice versa.

The radio 572 allows the system 502 to communicate with other computing devices, such as over a network. The radio 572 is one example of communication media. The embodiment of the system 502 is shown with two types of notification output devices: an LED 580 that can be used to provide visual notifications and an audio interface 574 that can be used with speaker 530 to provide audio notifications. These devices may be directly coupled to the power supply 570 so that when activated, they remain on for a duration dictated by the notification mechanism even though processor 560 and other components might shut down for conserving battery power. The LED 580 may be programmed to remain on indefinitely until the user takes action to indicate the powered-on status of the device. The audio interface 574 is used to provide audible signals to and receive audible signals from the user. For example, in addition to being coupled to speaker 530, the audio interface 574 may also be coupled to a microphone (not shown) to receive audible input, such as to facilitate a telephone conversation. In accordance with embodiments, the microphone may also serve as an audio sensor to facilitate control of notifications. The system 502 may further include a video interface 576 that enables an operation of on-board camera 530 to record still images, video stream, and the like.

A mobile computing device implementing the system 502 may have additional features or functionality. For example, the device may also include additional data storage devices (removable and/or non-removable) such as, magnetic disks, optical disks, or tape. Such additional storage is illustrated in FIG. 5B by storage 568.

Data/information generated or captured by the mobile computing device 550 and stored via the system 502 may be stored locally on the mobile computing device 550, as described above, or the data may be stored on any number of storage media that may be accessed by the device via the radio 572 or via a wired connection between the mobile computing device 550 and a separate computing device associated with the mobile computing device 550, for example, a server computer in a distributed computing network such as the Internet. As should be appreciated such data/information may be accessed via the mobile computing device 550 via the radio 572 or via a distributed computing network. Similarly, such data/information may be readily transferred between computing devices for storage and use according to well-known data/information transfer and storage means, including electronic mail and collaborative data/information sharing systems.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the embodiments described herein.

It will be apparent to those skilled in the art that various modifications or variations may be made without departing from the scope or spirit of the embodiments described herein. Other embodiments will be apparent to those skilled in the art from consideration of the specification and practice of the embodiments described herein.

What is claimed is:

1. A computer-implemented method for targeting content from an online service, comprising:
querying, by a server, a plug-in in a client application to determine whether an application is installed on a client computing device for viewing the content from the online service;
receiving, by the server, a response to the query from the plug-in;
querying, by the server, a web service to determine a license status for a roaming application for viewing the content from the online service on the client computing device;
receiving, by the server, a response to the query from the web service; and
presenting, by the server, at least one option for targeting the content from the online service to the client computing device based on the response to the query from the plug-in and the response to the query from the web service.

2. The method of claim 1, further comprising receiving a request from the client computing device to load a web page comprising the content, the content comprising at least one electronic document generated by a productivity software application.

3. The method of claim 1, wherein querying, by the server, the plug-in in the client application to determine whether an application is installed on the client computing device for viewing the content from the online service comprises querying the plug-in to determine whether a word processing application is installed on the client computing device for viewing the content from the online service.

4. The method of claim 1, wherein querying, by the server, the plug-in in the client application to determine whether an application is installed on the client computing device for viewing the content from the online service comprises querying the plug-in to determine whether a presentation application is installed on the client computing device for viewing the content from the online service.

5. The method of claim 1, wherein presenting, by the server, at least one option for targeting the content from the online service to the client computing device based on the response to the query from the plug-in and the response to the query from the web service comprises, upon determining that an application is installed on the client computing device for viewing the content from the online service and upon determining that there is a license for the roaming application based on the license status, then:
presenting a first option for viewing the content in the application installed on the client computing device;
presenting a second option for downloading the roaming application to the client computing device for viewing the content; and
presenting a third option for viewing the content in a web application provided by the online service.

6. The method of claim 1, wherein presenting, by the server, at least one option for targeting the content from the online service to the client computing device based on the response to the query from the plug-in and the response to the query from the web service comprises, upon determining that an application is not installed on the client computing device for viewing the content from the online service and upon determining that there is a license for the roaming application based on the license status, then:
presenting a first option for downloading the roaming application to the client computing device for viewing the content; and
presenting a second option for viewing the content in a web application provided by the online service.

7. The method of claim 1, wherein presenting, by the server, at least one option for targeting the content from the online service to the client computing device based on the response to the query from the plug-in and the response to the query from the web service comprises, upon determining that an application is installed on the client computing device for viewing the content from the online service and upon determining that there is not a license for the roaming application based on the license status, then:
presenting a first option for viewing the content in the application installed on the client computing device; and
presenting a second option for viewing the content in a web application provided by the online service.

8. The method of claim 1, wherein presenting, by the server, at least one option for targeting the content from the online service to the client computing device based on the response to the query from the plug-in and the response to the query from the web service comprises, upon determining that an application is not installed on the client computing device for viewing the content from the online service and upon determining that there is not a license for the roaming application based on the license status, then presenting an option for viewing the content in a web application provided by the online service.

9. A computer system for targeting content from an online service, comprising:
a memory for storing executable program code; and
a processor, functionally coupled to the memory, the processor being responsive to computer-executable instructions contained in the program code and operative to:
query a plug-in in a client application to determine whether an application is installed on a client computing device for opening the content from the online service;
receive a response to the query from the plug-in;
query a licensing service to determine a license status for a roaming application for viewing the content from the online service on the client computing device;
receive a response to the query from the licensing service; and
present one or more options for targeting the content from the online service to the client computing device based on the response to the query from the plug-in and the response to the query from the licensing service.

10. The system of claim 9, wherein the processor is further operative to receive a request from the client computing device to load a web page comprising the content.

11. The system of claim 9, wherein the processor, in querying the plug-in in the client application to determine whether an application is installed on the client computing device for opening the content from the online service, is operative to query the plug-in to determine whether one or more of a word processing application and a spreadsheet application is installed on the client computing device for opening the content from the online service.

12. The system of claim 9, wherein the processor, in presenting one or more options for targeting the content from the online service to the client computing device based on the response to the plug-in query and the response to the license query, is operative, upon determining that an application is installed on the client computing device for viewing the content from the online service and upon determining that there is a license for the roaming application based on the license status, to:
present a first option for opening the content in the application installed on the client computing device;
present a second option for downloading the roaming application to the client computing device for opening the content; and
present a third option for opening the content in a web application provided by the online service.

13. The system of claim 9, wherein the processor, in presenting one or more options for targeting the content from the online service to the client computing device based on the response to the plug-in query and the response to the license query, is operative, upon determining that an application is not installed on the client computing device for viewing the content from the online service and upon determining that there is a license for the roaming application based on the license status, to:
present a first option for downloading the roaming application to the client computing device for opening the content; and
present a second option comprising opening the content in a web application provided by the online service.

14. The system of claim 9, wherein the processor, in presenting one or more options for targeting the content from the online service to the client computing device based on the response to the plug-in query and the response to the license query, is operative, upon determining that an application is installed on the client computing device for viewing the content from the online service and upon determining that there is not a license for the roaming application based on the license status, to:
present a first option for opening the content in the application installed on the client computing device; and
present a second option for opening the electronic document in a web application provided by the online service.

15. The system of claim 9, wherein the processor, in presenting one or more options for targeting the content from the online service to the client computing device based on the response to the plug-in query and the response to the license query, is operative, upon determining that an application is not installed on the client computing device for viewing the content from the online service and upon determining that there is not a license for the roaming application based on the license status, to present an option comprising opening the content in a web application provided by the online service.

16. A computer-readable storage medium comprising computer executable instructions which, when executed by a computer, will cause the computer to perform a method for targeting an electronic document from an online service, the method comprising:
receiving a request from a client computing device to load a web page comprising the electronic document, the electronic document being generated by a productivity software application;
querying an ActiveX control in a web browser to determine whether a productivity software application is installed on a client computing device for opening the electronic document from the online service;
receiving a response to the query from the ActiveX control;
querying a licensing service to determine a license status for a roaming application for opening the electronic document from the online service on the client computing device;
receiving a response to the query from the licensing service; and
presenting at least one option for targeting the electronic document from the online service to the client computing device based on the response to the query from the ActiveX control and the response to the query from the licensing service.

17. The computer-readable storage medium of claim 16, wherein presenting at least one option for targeting the electronic document from the online service to the client computing device based on the response to the query from the ActiveX control and the response to the query from the licensing service comprises, upon determining that a productivity software application is installed on the client computing device for opening the content from the online service and upon determining that there is a license for the roaming application based on the license status, then:
presenting a first option for opening the electronic document in the productivity software application installed on the client computing device;
presenting a second option for downloading the roaming application to the client computing device for opening the electronic document; and
presenting a third option for opening the electronic content in a web application provided by the online service.

18. The computer-readable storage medium of claim 16, wherein presenting at least one option for targeting the electronic document from the online service to the client computing device based on the response to the query from the ActiveX control and the response to the query from the licensing service comprises, upon determining that a productivity software application is not installed on the client computing device for opening the content from the online service and upon determining that there is a license for the roaming application based on the license status, then:
presenting a first option for downloading the roaming application to the client computing device for opening the electronic document; and
presenting a second option comprising opening the electronic document in a web application provided by the online service.

19. The computer-readable storage medium of claim 16, wherein presenting at least one option for targeting the electronic document from the online service to the client computing device based on the response to the query from the ActiveX control and the response to the query from the licensing service comprises, upon determining that a productivity software application is installed on the client computing device for opening the content from the online service and upon determining that there is not a license for the roaming application based on the license status, then:
presenting a first option for opening the electronic document in the productivity software application installed on the client computing device; and
presenting a second option for opening the electronic document in a web application provided by the online service.

20. The computer-readable storage medium of claim 16, wherein presenting at least one option for targeting the electronic document from the online service to the client computing device based on the response to the query from the ActiveX control and the response to the query from the licensing service comprises, upon determining that a productivity software application is not installed on the client computing device for opening the content from the online service and upon determining that there is not a license for the roaming application based on the license status, then presenting an option for opening the electronic document in a web application provided by the online service.
